(19) United States
(12) Patent Application Publication
(10) Pub. No.: US 2010/0100415 A1
(43) Pub. Date: Apr. 22, 2010

(54) COMMON TAG FORMAT FOR AD SERVING AND INFORMATION TRACKING IN INTERNET ADVERTISING

(75) Inventors: Matt Plummer, Burbank, CA (US); Steven Hartman, Burbank, CA (US); Scott Shifflett, Stevenson Ranch, CA (US); Margaret Shih, Burbank, CA (US); Linda S. Lee, Santa Clara, CA (US)

Correspondence Address: MPG, LLP AND YAHOO! INC., 710 LAKEWAY DRIVE, SUITE 200, SUNNYVALE, CA, 94085, US

(73) Assignee: Yahoo!,Inc., Sunnyvale, CA (US)

(21) Appl. No.: 12/253,420

(22) Filed: Oct. 17, 2008

(51) Int. Cl. G06Q 30/00; G06Q 10/00

(52) U.S. Cl. 705/10; 705/14.49

(57) ABSTRACT

Systems, methods, and computer programs for implementing a common tag format in an Internet advertising and tracking system are provided. In one embodiment, the system includes an ad delivery system, a beacon system, and a management system. The ad delivery system serves ads to a browser visiting a publisher's web page. The beacon system collects usage data on the publisher's web site. The management system receives a service request, checks the request type of the service request, and then forwards the request to the ad delivery system, or to the beacon system, or to both, according to the request type. The service request is originated by a common tag embedded in the publisher's web page when loaded by a browser. The same common tag format is used for ad and tracking requests, thereby simplifying the management of the publisher's website and simplifying the migration process to change from just tracking a website to serving ads, merely by changing a parameter in the tag embedded in the publisher's page.

### BACKGROUND

1. Field of the Invention

The present invention relates to systems, methods, and computer programs for improving ad delivery and traffic tracking at internet publisher's sites, and more particularly, systems, methods and computer programs for implementing a common tag format for internet ad-delivery and traffic tracking.

2. Description of the Related Art

The computing industry has seen many advances in recent years, and such advances have produced a multitude of products and services. Internet websites are examples of products and services that are created to give users access to particular types of services, data, or searching capabilities. Online content providers, or publishers, are increasingly moving towards building World Wide Web sites that are more reliant on dynamic, frequently-updated content.

Advertisements are displayed on many websites to generate income. Website publishers are often paid based on the number of clicks an advertisement receives through the publisher's website. Thus, it can be beneficial to target advertising toward particular categories of products and/or services that are attractive to the audience of a particular website. Coding individual advertisement for a website can be a time consuming process. Each advertisement may require specification of parameters such as size, placement, along with the product or service category of advertisement to be displayed in the ad space. Additionally, publishers wish to collect different types of information about their website, such as information on users visiting the website, how visitors use the website, ad inventory forecasting, click-through rates, etc.

However, collecting information typically requires embedding small pieces of code in each website page, same as setting up ad serving in each of the different pages. This results in duplicity of efforts and added complexity to the management of a publisher's website.

It is in this context that embodiments of the invention arise.

### SUMMARY

Embodiments of the present invention provide systems, methods, and computer programs for implementing a common tag format in an Internet advertising and tracking system. In one embodiment, the system includes an ad delivery system, a beacon system, and a management system (also referred to herein as a federated system). The ad delivery system serves ads to a browser visiting a publisher's web page. The beacon system collects usage data on the publisher's web site. The management system receives a service request, checks the request type of the service request, and then forwards the request to the ad delivery system, or to the beacon system, or to both, according to the request type. The service request is originated by a common tag embedded in the publisher's web page when loaded by a browser. The same common tag format is used for ad and tracking requests, thereby simplifying the management of the publisher's website and simplifying the migration process to change from just tracking a website to serving, merely by changing a parameter in the tag embedded in the publisher's page.

It should be appreciated that the present invention can be implemented in numerous ways, such as a process, an apparatus, a system, a device or a method on a computer readable medium. Several inventive embodiments of the present invention are described below.

In one embodiment, a method implementing a common tag format in an Internet advertising and tracking system. The method includes receiving a service request originated by a common tag embedded in a publisher's web page when loaded by a browser. The method further parses the service request to identify parameters included in the service request, such as the request type parameter. An ad is served to the user's browser when the request type parameter indicates that an ad as been requested, and a tracking item is delivered to the browser when the request type parameter indicates that usage data has been requested but an ad has not been requested. In another embodiment, a computer program embedded in a computer-readable storage medium performs the method.

Other aspects of the invention will become apparent from the following detailed description, taken in conjunction with the accompanying drawings, illustrating by way of example the principles of the invention.

### BRIEF DESCRIPTION OF THE DRAWINGS

The invention may best be understood by reference to the following description taken in conjunction with the accompanying drawings in which:

FIG. 1 describes a simplified schematic diagram of a network system for implementing embodiments of the present invention.

FIG. 2 depicts the process for serving ads and tracking website information in accordance with one embodiment of the invention.

FIG. 3 describes the architecture of a server managing federated ad calls, according to one embodiment.

FIG. 4 includes information regarding the Request Type parameter in accordance with one embodiment of the invention.

FIG. 5 describes the flow to process ad and beacon requests, according to one embodiment.

FIG. 6 shows the flow of an algorithm for implementing a common tag format for internet ad-delivery and traffic tracking in accordance with one embodiment of the invention.

FIG. 7 is a simplified schematic diagram of a computer system for implementing embodiments of the present invention.

### DETAILED DESCRIPTION

The following embodiments describe a method and apparatus for implementing a common tag format in an Internet advertising and tracking system, to simplify data tracking and ad serving requirements.

A typical ad request contains most of the information for publishers to track site data and user data (whether it is for forecasting or user segmentation tracking and targeting). Existing solutions for ad requests and user tracking require publishers to embed multiple codes on a web page, even though the same exact data will be collected. However, because the codes are aimed at different purposes and systems, existing solutions require entering the different codes separately causing duplicity of efforts.

Embodiments of the present invention leverage the data that gets passed via each ad request to collect the same data for different purposes (e.g. forecasting or user tracking). This simplifies website management for publishers because one code can be used for multiple purposes and publishers do not have to embed different codes on the same page for different purposes. Instead of constantly adding and removing codes on a web page, publishers only have to create one code. For example, a publisher can start by doing segmentation tracking, and just by changing one parameter, publishers can start requesting ads and inventory forecasting. Based on the Request Type parameter, the method determines which system gets the data and what data to track based on this parameter.

It will be obvious, however, to one skilled in the art, that the present invention may be practiced without some or all of these specific details. In other instances, well known process operations have not been described in detail in order not to unnecessarily obscure the present invention.

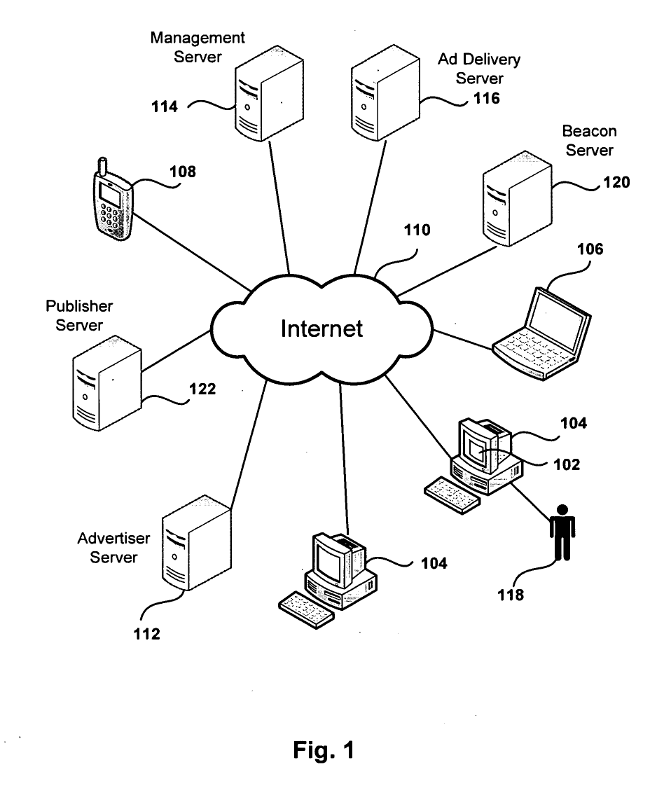

FIG. 1 describes a simplified schematic diagram of a network system for implementing embodiments of the present invention. Internet 110 is used to interconnect users with servers. Users 118 access the Internet 110 via a variety of the devices, such as PCs 104, laptops 106, mobile phones 108, etc. These are merely examples, and any other device used to access Internet 110 can be used to implement embodiments of this invention. For example, the devices may be wired or wireless. In one embodiment, a browser 102 is executed on a device, and the graphical user interface is presented on a display. Browser 102 provides the functionality for accessing the Internet.

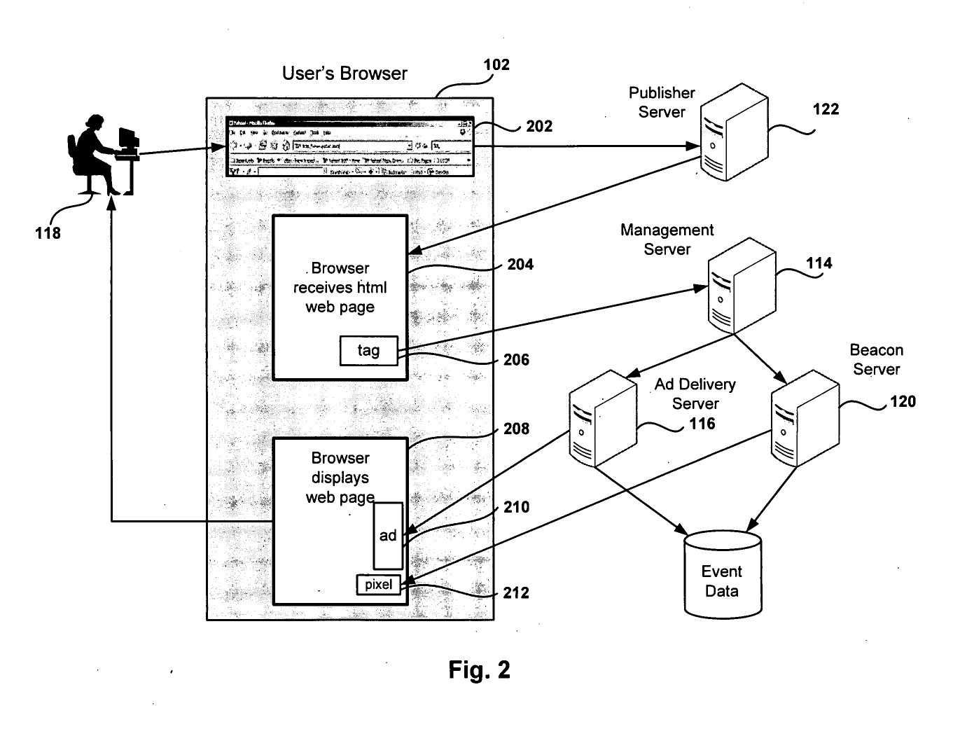

Management server 114 provides ad delivery and user tracking services to Internet users and Publishers. An Internet ad is a commercial message in one of several formats, such as graphical or rich media. An ad call is a request for an ad, sent from the publisher to the ad management platform. The ad management platform can reside in one server, or can be distributed across several servers, such as management server 114, ad delivery server 116, and beacon server 120. One or more requests are sent to the ad management platform whenever a user browses to a publisher's web page. Each ad call includes criteria that the ad management platform can use to select and deliver the ad or ads for the web page. The ad call is generated automatically from the ad code embedded on the publisher page, as described below with respect to FIG. 2. The ad code is also called an ad tag. Some embodiments detailed below used javascript as the language used for creating tags, but any other language can be used. Some examples of existing ad management platforms include Yahoo!®, Doubleclick®, and Google®.

Ad delivery server 116 delivers ads to users accessing publisher's web pages, and beacon server 120 manages the user tracking process. Advertiser server 112 interacts with the ad management platform to supply the ads. Although different servers are described by way of example, the person skilled in the art will appreciate that multiple configurations are possible by combining several servers into one system, by having distributed systems where a single function can be accomplished by a plurality of different servers scattered across the Internet, or by caching information from the different databases at the different servers to accelerate the processing of information.

FIG. 2 depicts the process for serving ads and tracking website information in accordance with one embodiment of the invention. As user's web browser 102 renders a publisher's webpage supplied by publisher server 122, the tag (i.e. a javascript) embedded in the web page automatically sends an HTTP message requesting the ad to management server 114, also referred to herein as the federated server. The management server passes ad requests to the ad delivery server 116, which returns an ad to user's browser 102. Additionally, ad delivery server 116 logs event data related to the ad request.

When an ad is not requested, and the publisher has set up the web page for tracking by the ad management platform, management server sends the request to beacon server 120. As a result, beacon server 120 delivers a beacon to browser 102. A beacon is a browser-renderable file embedded in a web page to track traffic to the web page. When a user views the page, the beacon triggers a message to the Web server. Beacons are used to track user activity, including customer click patterns for a site. In one embodiment, the beacon is a 1×1 pixel file, but any other browser-renderable file can be used as a beacon. The user's cookie for the ad serving domain (currently yieldmanager.net) may also be created or updated.

A typical tag using the javascript language contains two main sections: a parameter section; and a script for ad call management. The parameters specify a set of inputs used by the federated (management) server for query processing. More specifically, parameters relate information about the site, publisher preferences, and publisher ad requirements, as well as geographic, demographic, and content information related to the original user query. All this information is used to serve relevant ads. Below is an example of a portion of the query parameter block.

<script type=“text/javascript”><!--
yld_mgr = { };
yld_mgr.pub_id=“12345678901”;
yld_mgr.site_name=“mysite”;
yld_mgr.container_type=“js”;
yld_mgr.request_type=“ac”;
yld_mgr.ad_size_list=[“300×250”,“250×250”];
yld_mgr.ad_delivery_mode=“ipatf”;
//additionalparameters as needed...
//--> </script>

In this example, the script for ad call management is script.js. This file does the following:

1.—Constructs and sends a query URL to the federated server, and

2.—Renders the ad on the page. For example, the ad size is based on the parameters specified.

Below is an example of the call for the ad call management script.

<script type=“text/javascript”
src=“http://e.yieldmanager.net/script.js”>
</script>

Below is one embodiment of a code bundle defining a plurality of parameters. Some parameters are required, while other parameters are optional.

//Query Parameter Block
<script type=“text/javascript”><!--
yld_mgr = { };
//REQUIRED PARAMETERS
yld_mgr.pub_id=“12345678901”;
yld_mgr.site_name=“mysite”;
yld_mgr.ad_size_list=[“300×250”,“250×250”];
yld_mgr.request_type=“ac”;
//OPTIONAL PARAMETERS THAT DESCRIBE THE AD
yld_mgr.container_type=“js”;
yld_mgr.ad_delivery_mode=“ipatf”;
yld_mgr.clk_dest=“_blank”;
yld_mgr.ad_output_encoding=“utf-8”;
//OPTIONAL PARAMETERS FOR GEOGRAPHIC TARGETING
yld_mgr.user_city=“Los Angeles”;
yld_mgr.user_dma=“Los Angeles”;
yld_mgr.user_state=“California”;
yld_mgr.user_zip=“91605”;
yld_mgr.user_country=“US”;
//OPTIONAL PARAMETERS FOR DEMOGRAPHIC TARGETING
yld_mgr.user_age=“25-29”;
yld_mgr.user_gender=“female”;
yld_mgr.user_income=“35000-49999”;
//OPTIONAL PARAMETERS THAT DESCRIBE THE SITE CONTENT
yld_mgr.content_topic_id_list=[“12345”,”22334”];
yld_mgr.cstm_content_cat_list=[“Sacramento High
School”,“dragons”];
yld_mgr.content_type_list=”fn_ec;
yld_mgr.site_section_name_list=[“homepage”];
yld_mgr.ad_content_lang=“en-US”;
//OPTIONAL PARAMETERS THAT DEFINE YOUR PREFERENCES
yld_mgr.reporting_tag_list=[“banner group A”,“banner group B”];
//OPTIONAL DISABLE CONTENT SEND
yld_mgr.disable_content_send=“0”;
//--> </script>
//Script for Query Management
<script type=“text/javascript”
src=“http://e.yieldmanager.net/script.js”>
</script>

This code will deliver one add, but similar can be configured to deliver multiple ads in one call. Automated software utilities associated with the ad management platform enable a publisher to quickly and easily create the tags following simple instructions.

For some pages on a publisher's site, the publisher does not wish for an ad to be served, but may wish to record or track the user as the user progress through the publisher's site. In this case, a tracking beacon call is inserted into the page to create the call to the federated ad server when the page is rendered. No ads are returned from the tracking beacon call to the federated ad server.

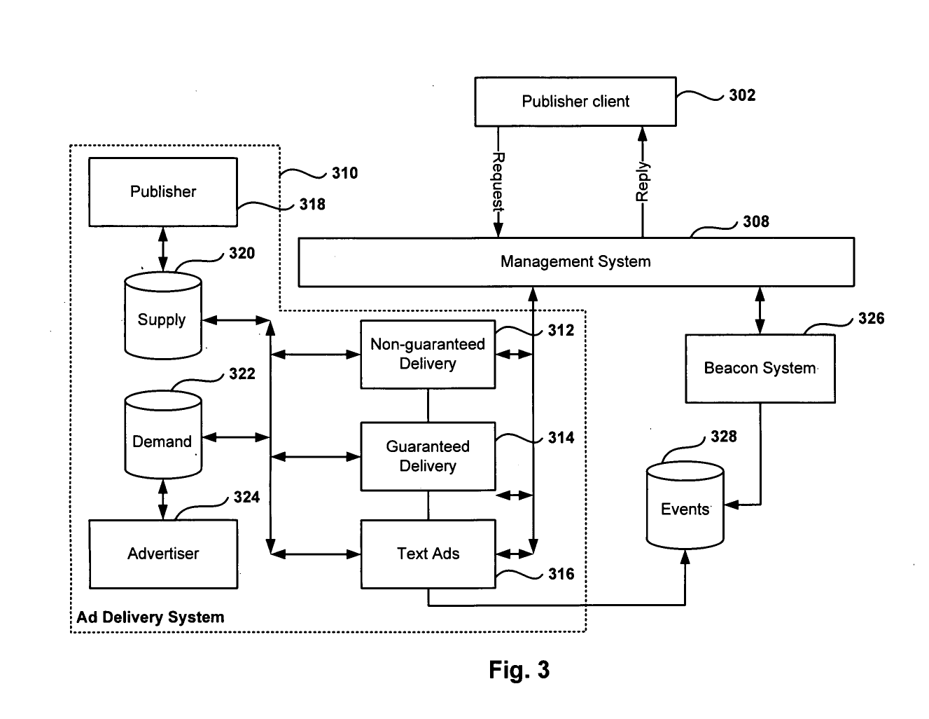

FIG. 3 describes the architecture of a server managing federated ad calls, according to one embodiment. A request from publisher client 302 is sent to management system 308, which analyzes the request and invokes ad delivery system 310 or beacon system 326, or both in parallel. Ad delivery system 310 includes several Connection Tactics (CT). The first CT is the non-guaranteed delivery CT, which, as its name describes, delivers ads but without guaranteed that an ad will be available given the parameters in the request. The second CT is the guaranteed delivery CT, which delivers ad with the guarantee to the publisher that an ad will be delivered. Finally, the third CT is the text ad CT 316, which delivers text ads.

The three CTs check information on ad supply 320 and demand 322 to determine if an ad, or multiple ads, will be returned for this request. The CTs will also log event data to keep track of user and website statistics, as needed. Once management system 308 receives a reply from one or several CTs, the reply is forwarded to publisher client 302, which originated the request.

If the request includes a beacon call, management system 308 will forward the request to beacon system 326, which will also log event data as needed. If no ad is being returned to the user, the beacon system will return a beacon to publisher client 302 via management system 308.

As previously described, a publisher is interested in serving ads to a clients and in knowing how the publisher's website is being used, which users are visiting, what are the most popular sections, etc. In many cases, a publisher will be subscribed to an ad delivery platform, but the publisher whishes to do website tracking using tracking services from another platform. In this case, the publisher will create two separate tags, one for ad delivery and the other one for web tracking.

In one embodiment, a common format is used for both ad delivery and beacons. The publisher may use the common format initially to do web tracking. However, if the publisher wishes later on to do ad delivery, all the publisher has to do is to switch one parameter in the tag, and the system will start delivering ads without the additional investment tag development time. In the case that the publisher starts by implementing ad serving in the system of FIG. 3, changing one parameter in the tags, will quickly enable the publisher to start collecting user and ad-forecasting data.

By employing a federated ad call system, the same tags can be used for ads and beacons, because the federated ad call system can process both types of requests.

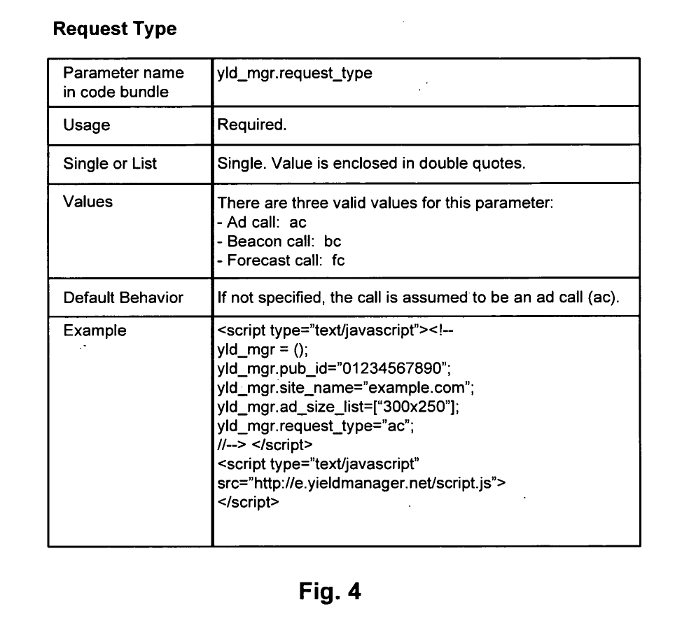

FIG. 4 includes information regarding the Request Type parameter in accordance with one embodiment of the invention. Tag parameters convey information to the federated server, such as instructions about ad requirements and preferences. In one embodiment, the Request type parameters can have three values:
“ac” for an ad call
“bd” for a beacon call, and
“fc” for an ad inventory forecast call

If the request type parameter is not specified in the tag, the default value is “ac”. While these parameters are presented as a way of example, other parameters can be used to define a request type.

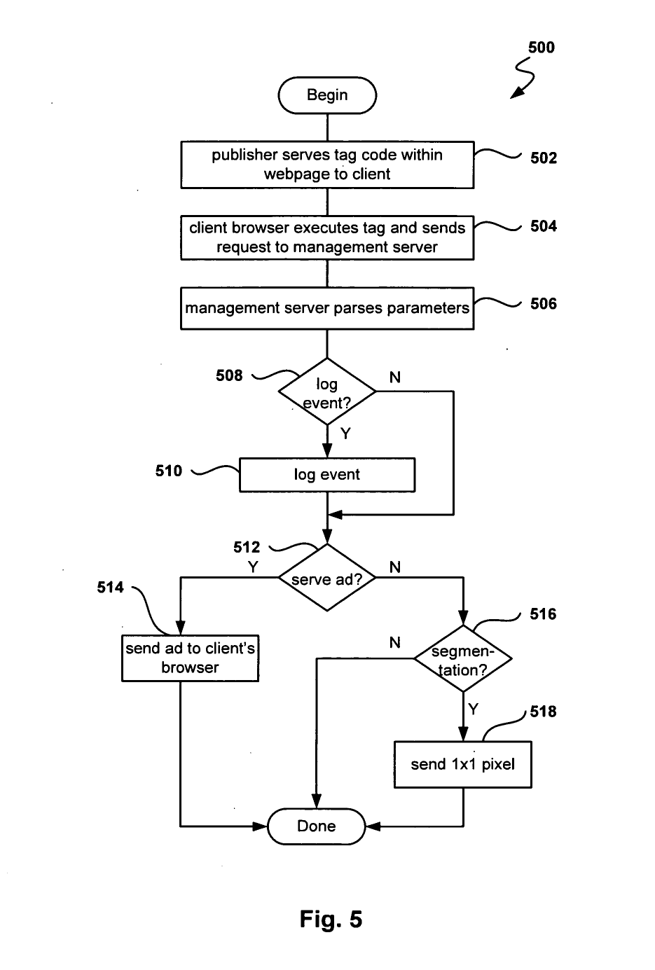

FIG. 5 describes the flow to process ad and beacon requests, according to one embodiment. In operation 502, the publisher serves a tag code, embedded within a web page, to a client's browser. In operation 504, the client browser executes the tag and sends a request to the management server. In one embodiment, the system of FIG. 2 is used to send the request to the management system.

The management server parses the parameters in operation 506. Checking whether the call must be logged is performed in operation 508, and if checking is required, the event is logged in operation 510. The method continues in operation 512, where the management server checks whether an ad will be served to the client. In one embodiment, the check is performed by the different CTs previously described with respect to FIG. 3. If an ad is being served, then the ad is served in operation 514. If the ad is not being served, then operation 516 checks whether this is a segmentation call (beacon call). If this is a beacon call, then a beacon (1×1 pixel) is sent in operation 518.

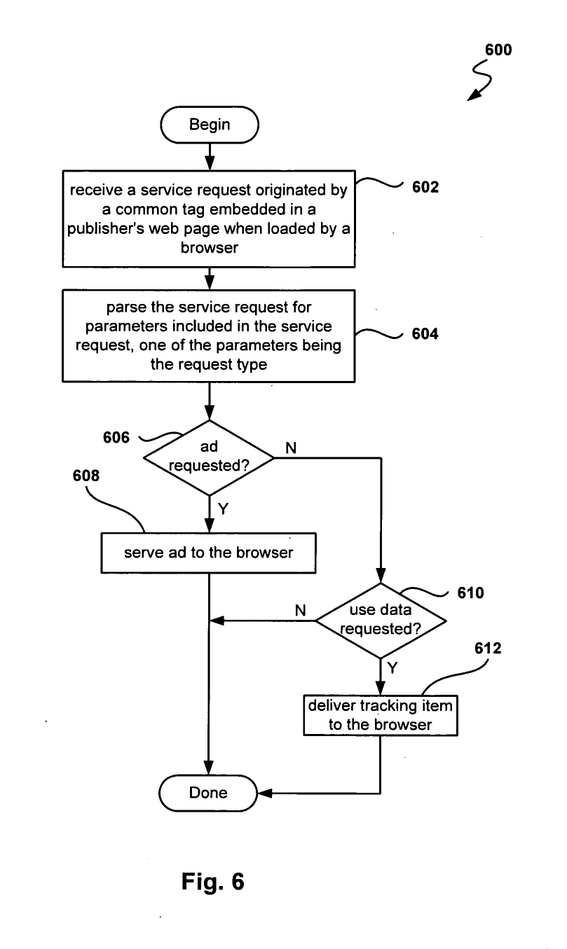

FIG. 6 shows the flow of an algorithm for implementing a common tag format for internet ad-delivery and traffic tracking in accordance with one embodiment of the invention. In operation 602, the method includes receiving a service request originated by a common tag, where the tag is embedded in a publisher's web page being loaded by a browser. In operation 604, the service request is parsed to identify the parameters included in the service request. One of the parameters is the request type parameter, such as the one for the embodiment presented in FIG. 4. Operation 606 checks if an ad was requested, and if the ad was requested, then the ad is served to the browser in operation 608.

If the ad was not requested, the method checks whether use data (beacon) was requested. If the use data was requested (and an ad was not requested), then a tracking item (beacon) is sent to the client in operation 612.

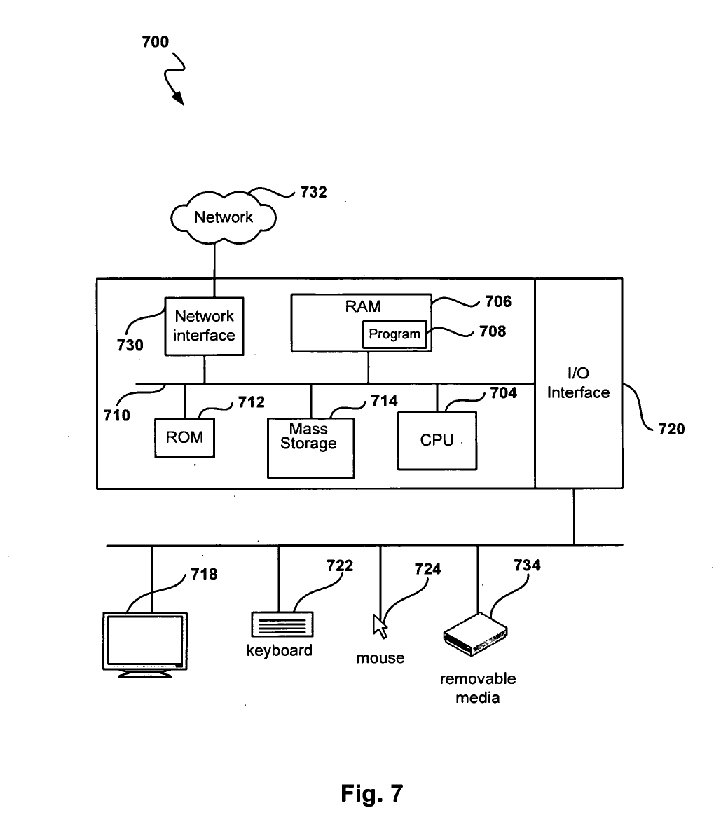

FIG. 7 depicts a computer environment for implementing embodiments of the invention. It should be appreciated that the methods described herein may be performed with a digital processing system, such as a conventional, general-purpose computer system. Special purpose computers, which are designed or programmed to perform only one function may be used in the alternative. The computer system includes a central processing unit (CPU) 704, which is coupled through bus 710 to random access memory (RAM) 706, read-only memory (ROM) 712, and mass storage device 714. Ad management program 708 resides in random access memory (RAM) 706, but can also reside in mass storage 714.

Mass storage device 714 represents a persistent data storage device such as a floppy disc drive or a fixed disc drive, which may be local or remote. Network interface 730 provides connections via network 732, allowing communications with other devices. It should be appreciated that CPU 704 may be embodied in a general-purpose processor, a special purpose processor, or a specially programmed logic device. Input/Output (I/O) interface provides communication with different peripherals and is connected with CPU 704, RAM 706, ROM 712, and mass storage device 714, through bus 710. Sample peripherals include display 718, keyboard 722, cursor control 724, removable media device 734, etc.

Display 718 is configured to display the user interfaces described herein, such as browser 102 from FIG. 1. Keyboard 722, cursor control 724, removable media device 734, and other peripherals are coupled to I/O interface 720 in order to communicate information in command selections to CPU 704. It should be appreciated that data to and from external devices may be communicated through I/O interface 720. The invention can also be practiced in distributed computing environments where tasks are performed by remote processing devices that are linked through a wire-based or wireless network.

Embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network.

With the above embodiments in mind, it should be understood that the invention can employ various computer-implemented operations involving data stored in computer systems. These operations are those requiring physical manipulation of physical quantities. Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

Although the method operations were described in a specific order, it should be understood that other housekeeping operations may be performed in between operations, or operations may be adjusted so that they occur at slightly different times, or may be distributed in a system which allows the occurrence of the processing operations at various intervals associated with the processing, as long as the processing of the overlay operations are performed in the desired way.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. An Internet ad-delivery and web-tracking system for implementing a common tag format, the system comprising:
an ad delivery system that serves ads;
a beacon system that collects usage data; and
a management system that receives a service request and checks a request type of the service request, the management system forwarding the request to at least one of the ad delivery system or the beacon system according to the request type;
wherein the service request is originated by a common tag embedded in a publisher's web page when loaded by a browser;
wherein the ad delivery system serves an ad to the browser when the request is forwarded to the ad delivery system;
wherein the beacon system delivers a tracking item to the browser when the request is not forwarded to the ad delivery system.

2. The system of claim 1,
wherein the request type indicates that tracking data is to be collected and no ads are to be served, and
wherein the ad delivery system starts delivering ads and the beacon system continues collecting tracking data when the request type is changed in the common tag.

3. The system of claim 1, wherein the beacon system further collects ad inventory forecast information.

4. The system of claim 3, wherein the request type is selected from a group consisting of,
an ad call to request an ad,
a beacon call to collect user data, or
a forecast call for forecasting ad inventory.

5. The system of claim 1, wherein the common tag includes a javascript.

6. The system of claim 1, wherein the ad delivery system further includes,
a guaranteed ad-delivery connection tactic (CT) system that guarantees ad delivery when invoked,
a non-guaranteed CE system that does not guarantee ad delivery when invoked, and
a text ad-delivery system CT that delivers text ads.

7. The system of claim 1, wherein the ad delivery system delivers a plurality of ads in response to the service request.

8. A method for implementing a common tag format in an Internet advertising and tracking system, the method comprising:
receiving a service request originated by a common tag embedded in a publisher's web page when loaded by a browser;
parsing the service request to identify parameters included in the service request, the parameters including a request type parameter;
serving an ad to the browser when the request type parameter indicates that an ad as been requested; and
delivering a tracking item to the browser when the request type parameter indicates that usage data has been requested and that the ad has not been requested.

9. The method of claim 8, further including,
logging event data associated with the service request.

10. The method of claim 8, wherein the request type is selected from a group consisting of,
an ad call to request an ad,
a beacon call to collect user data, or
a forecast call for forecasting ad inventory.

11. The method of claim 8, further including,
generating the common tag by a tag generating program, and
inserting the common tag generated in the html code of the publisher's the web page.

12. The method of claim 8, further including,
receiving user cookie information associated with the service request, and
logging an event based on the cookie information.

13. The method of claim 8, wherein the request type indicates that user data is to be collected and no ads are to be served, the method further including,
changing the request type in the common tag to start delivering ads and continue collecting user data.

14. The method of claim 8, wherein the tracking item is a 1×1 pixel.

15. The method of claim 14, further including,
sending a usage message, triggered the 1×1 pixel, when a user views the publisher's web page including the 1×1 pixel.

16. A computer program embedded in a computer-readable storage medium, when executed by one or more processors, for implementing a common tag format in an Internet advertising and tracking system, the computer program comprising:
program instructions for receiving a service request originated by a common tag embedded in a publisher's web page when loaded by a browser;
program instructions for parsing the service request to identify parameters included in the service request, the parameters including a request type parameter;
program instructions for serving an ad to the browser when the request type parameter indicates that an ad as been requested; and
program instructions for delivering a tracking item to the browser when the request type parameter indicates that usage data has been requested and that the ad has not been requested.

17. The computer program of claim 16, wherein the request type is selected from a group consisting of,
an ad call to request an ad,
a beacon call to collect user data, or
a forecast call for forecasting ad inventory.

18. The computer program of claim 17, further including,
program instructions for generating segmentation data associated with the publisher's web page based on collected user data.

19. The computer program of claim 16, further including,
program instructions for generating the common tag by a tag generating program, and
program instructions for inserting the common tag generated in the html code of the publisher's the web page.

20. The computer program of claim 16, wherein the common tag includes a javascript.
